(19) United States
(12) Patent Application Publication
(10) Pub. No.: US 2007/0007675 A1
(43) Pub. Date: Jan. 11, 2007

(54) Method of manufacturing compound optical element and compound optical element module

(75) Inventor: Youhei Nakagawa, Katano-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-shi (JP)

(21) Appl. No.: 11/482,755

(22) Filed: Jul. 10, 2006

(30) Foreign Application Priority Data
Jul. 11, 2005 (JP) 2005-201734(P)

(51) Int. Cl. B29D 11/00

(52) U.S. Cl. 264/1.7; 264/1.38

(57) ABSTRACT

A method of manufacturing a compound optical element that reduces any damage to the mold and the lens base material caused by tight contact between the mold and the resin layer, enables easy control of thickness of the resin layer and realizes high productivity is provided. For this purpose, the method of manufacturing a compound optical element having a resin layer on a surface of a base material includes the steps of: applying a liquid of ultraviolet curing resin to at least one of the base material and the mold body; adjusting arrangement of the base material and the mold body; curing the liquid of ultraviolet curing resin at an outer circumference of a release facilitating region; curing the liquid of ultraviolet curing resin at the release facilitating region; and separating a resin layer formed by curing from the mold body.

### BACKGROUND OF THE INVENTION

1. Field of the Invention

The present invention relates to a method of manufacturing a compound optical element such as an aspheric lens, Flesnel lens, achromatic lens, diffraction grating, diffraction grating lens or a mirror, having resin formed in tight contact on a surface of a base lens of glass, on an interface between base lenses of glass, or on a mirror. The present invention further relates to a compound optical element module using such an element.

2. Description of the Background Art

Recently, a technique of forming an active energy-ray curing resin such as an ultraviolet curing resin in tight contact on a surface of a glass base material has been developed and come to be used in a method of manufacturing an aspherical lens or the like. By way of example, as disclosed in Japanese Patent Laying-Open No. 01-171932, a method of manufacturing an aspherical lens has been known, which includes the steps of filling a liquid of ultraviolet curing resin or the like between a lens base material and a mold processed to have an aspherical surface, curing the liquid resin to form a first layer and releasing from the mold; and again performing the same process as the first layer molding process to form a second layer. According to this method, though volume shrinkage of about 7 to 8% is generated at the time of molding the first layer, by performing the second layer molding process that is the same as the first layer molding process, apparent volume shrinkage could be reduced to 0.5 to 0.6%, and highly precise and reliable aspherical lens could be manufactured.

Further, as described in Japanese Patent Laying-Open No. 03-013902, a method of manufacturing a compound optical element including a lens base material and a resin layer has been known, which method includes the steps of filling a liquid of ultraviolet curing resin between a mold and the lens base material, forming the resin layer on the surface of the lens base material by curing and releasing the resulting body from the mold, wherein an annular projecting line or a recessed groove is formed at an outer circumference of the resin layer forming surface of the lens base material or the mold. According to this technique, when the resin liquid on the lens base material is pressed and spread by the mold, the resin liquid spreads along the projected groove or the recessed groove formed annularly at the outer circumference, and not go out further therefrom, and therefore, positional deviation could be avoided and a resin layer having high roundness could be formed.

When a resin layer is to be formed on a surface of a lens base material using a mold, however, the mold and the resin layer are brought into tight contact with each other and, therefore, the mold comes to have shorter life, possibly causing damage on the lens base material at the time of releasing. Considering such a problem, a method of applying a fluorine based releasing agent to the mold, or a method of providing a releasing projection on the mold have been proposed, as described, for example, in Japanese Patent Laying-Open No. 05-070153. When the releasing agent is applied to the mold, however, form precision degrades, and hence, the releasing layer must be made very thin. Further, after a number of transfers, the releasing agent must be applied again. Therefore, this approach is not suitable for mass production. Recently, portable telephones, digital cameras and the like have been reduced in size, and optical system itself comes to be smaller. Accordingly, a compound lens comes to have larger effective diameter relative to the outer diameter, and therefore, it is difficult to take a space for providing a projection outside the optically effective diameter of the mold.

### SUMMARY OF THE INVENTION

An object of the present invention is to provide a method of manufacturing a compound optical element that reduces any damage to the mold and the lens base material caused by tight contact between the mold and the resin layer, enables easy control of thickness of the resin layer and realizes high productivity. Another object is to provide a compound optical element module using the element manufactured through such a method.

In order to attain the objects, the present invention provides a method of manufacturing a compound optical element having a resin layer on a surface of a base material, including the steps of: applying a liquid of ultraviolet curing resin to at least one of the base material and a mold body; adjusting arrangement of the base material and the mold body; curing the liquid of ultraviolet curing resin at an outer circumference of a release facilitating region provided to ease releasing from the mold body; curing the liquid of ultraviolet curing resin at the release facilitating region; and releasing step of separating a resin layer formed by curing from the mold body.

According to another aspect, the present invention provides a method of manufacturing a compound optical element having a resin layer on a surface of a base material, including the steps of: applying a liquid of ultraviolet curing resin to at least one of the base material and a mold body; adjusting arrangement of the base material and the mold body; curing the liquid of ultraviolet curing resin at an outer circumference of a release facilitating region and at a form stabilizing region; releasing step of separating a resin layer formed by curing from the mold body; at least in the form stabilizing region, applying a liquid of ultraviolet curing resin to at least one of the resin layer and the mold body; adjusting arrangement of the resin layer and the mold body; curing the liquid of ultraviolet curing resin at least in the form stabilizing region and in the release facilitating region; and releasing step of separating a resin layer formed by curing from the mold body.

The compound optical module in accordance with the present invention is characterized in that the compound optical element manufactured through such a method is used as a medium for condensing and/or reflecting light.

According to the present invention, a method of manufacturing a compound optical element allowing easy control of the form of resin layer and attaining high productivity can be provided. Further, the highly precise compound optical element in accordance with the present invention may be used as an aspherical lens, Flesnel lens, achromatic lens, a diffusion grating or a diffusion grating lens, to manufacture a compound optical element module for an optical pickup or a camera for a portable telephone. Therefore, a highly precise compound optical element module can be provided.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIGS. 1A to 1D are cross sectional views showing steps of manufacturing a compound optical element in accordance with Example 1 of the present invention.

FIGS. 2A to 2C are cross sectional views showing steps of manufacturing a compound optical element in accordance with Comparative Example 1.

FIGS. 3A to 3D are cross sectional views showing steps of manufacturing compound optical elements in accordance with Example 2 and Example 5 of the present invention.

FIGS. 4A to 4D are cross sectional views showing steps of manufacturing a compound optical element in accordance with Example 3 of the present invention.

FIGS. 5A to 5D are cross sectional views showing steps of manufacturing a compound optical element in accordance with Comparative Example 2.

FIGS. 6A to 6D are cross sectional views showing steps of manufacturing a compound optical element in accordance with Example 4 of the present invention.

FIGS. 7A to 7C are cross sectional views showing steps of manufacturing a compound optical element in accordance with Example 6 of the present invention.

FIGS. 8A to 8G are cross sectional views showing steps of manufacturing a compound optical element in accordance with Example 7 of the present invention.

FIGS. 9A to 9F are cross sectional views showing steps of manufacturing a compound optical element in accordance with Example 8 of the present invention.

### DESCRIPTION OF THE PREFERRED EMBODIMENTS

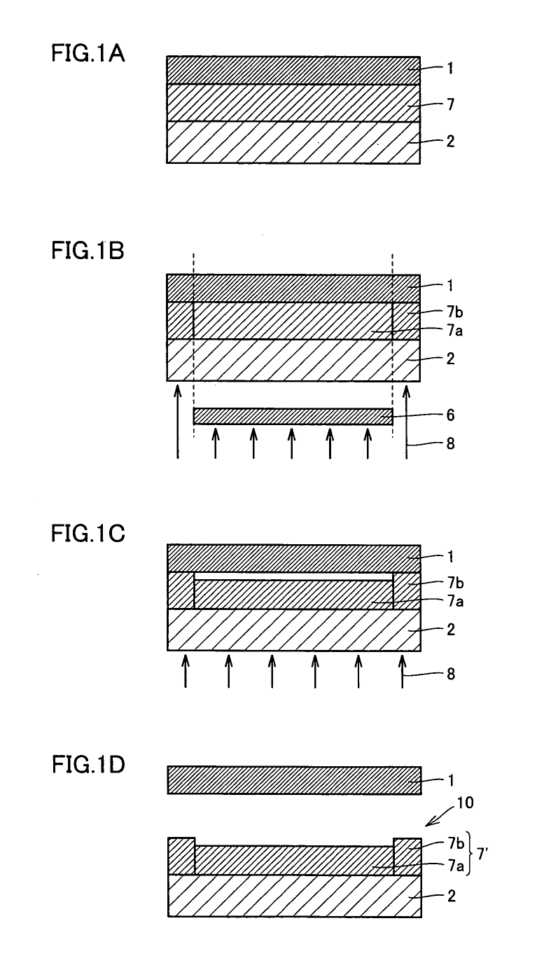

FIGS. 1A to 1D are cross sectional views showing steps of manufacturing a compound optical element in accordance with Example 1 of the present invention. According to the manufacturing method, first, as shown in FIG. 1A, a liquid of ultraviolet curing resin 7 is applied to at least one of a base material 2 such as a lens base material and a mold body 1, and arrangement of base material 2 and mold body 1 is adjusted while avoiding generation of any bubble. As mold body 1, a mold formed of nickel or the like or a transparent quartz mold may be used. As to the adjustment of arrangement of the base material and mold body, base material 2 and mold body 1 may be arranged not in contact but spaced from each other by about 10 μm, for example, as shown in FIG. 1A, if a mechanism for precise positioning between the base material and the mold body is available. Alternatively, a surface of the mold body to be in contact with the resin liquid may be subjected to aspheric machining process (not shown), so that it is possible to place the resin liquid at a processed recessed portion at the surface of the mold body, with the mold body and the base material brought into contact with each other. Thereafter, as shown in FIG. 1B, by irradiation of ultraviolet ray 8 through a screen 6, the liquid of ultraviolet curing resin at an outer circumference 7b of a release facilitating region 7a, which is provided to ease releasing, is cured. Then, as shown in FIG. 1C, screen 6 is removed, and again by irradiation of ultraviolet ray 8, the liquid of ultraviolet curing resin in release facilitating region 7a is cured. Finally, as shown in FIG. 1D, resin layer 7′ is released from mold body 1, whereby a compound optical element 10 having the resin layer 7′ on the surface of base material 2 is obtained.

Of the resin liquid 7 on base material 2, the liquid on outer circumference 7b of release facilitating region 7a is cured first, in order to stop supply of the resin liquid from the periphery when the release facilitating region 7a is cured and shrunken. By providing release facilitating region 7a of resin liquid 7 on base material 2, curing the outer circumference 7b of release facilitating region 7a first and then curing release facilitating region 7a, the resin layer in release facilitating region 7a come to shrink well in release facilitating region 7a, attaining better releasing property. The resin at outer circumference 7b of release facilitating region 7a cures while the resin liquid is supplied sufficiently, and therefore, the thickness of the resin layer at the outer circumference 7b can be controlled easily.

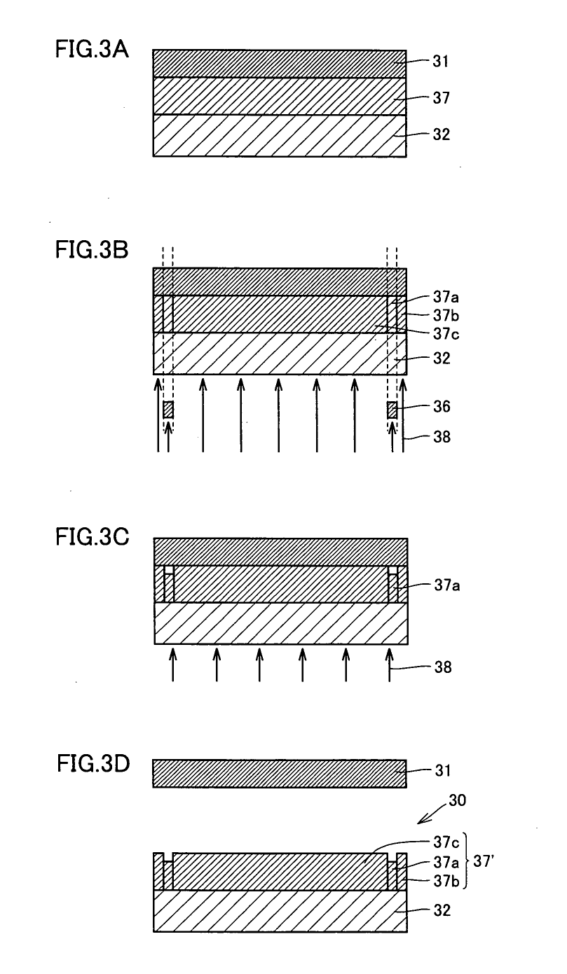

The position of release facilitating region may be arbitrarily set considering the intended compound optical element, and release facilitating region 7a may be set at the central portion of the optical element as shown in FIG. 1D. Alternatively, a release facilitating region 37a may be provided outside a form stabilizing region 37c provided for stabilizing the form of the resin layer, as shown in FIG. 3D. It is not always necessary to provide the release facilitating region at the outer circumference of the form stabilizing region, and when it is provided at least on a portion outside the form stabilizing region, releasing is facilitated. If it is necessary to form the release facilitating region within the form stabilizing region, which is a desired region that requires high form precision, the release facilitating region should preferably be made sufficiently small, so as not to cause any optical problem.

FIGS. 3A to 3D are cross sectional views showing different steps of manufacturing a compound optical element in accordance with the present invention. According to this manufacturing method, first, as shown in FIG. 3A, a liquid of ultraviolet curing resin 37 is applied to at least one of a base material 32 and a mold body 31, and arrangement of the base material and the mold body is adjusted. Then, as shown in FIG. 3B, by irradiation of ultraviolet ray 38 through a screen 36, the liquid of ultraviolet curing resin at outer circumference 37b of release facilitating region 37a and the liquid of ultraviolet curing resin at form stabilizing region 37c are cured. Thereafter, as shown in FIG. 3C, screen 36 is removed, and again by irradiation of ultraviolet ray 38, the liquid of ultraviolet curing resin in release facilitating region 37a is cured. Finally, as shown in FIG. 3D, resin layer 37′ is released from mold body 31, whereby a compound optical element 30 having the resin layer 37′ on the surface of base material 32 is obtained.

In this manner, it is preferred that the step (FIG. 3C) of curing the ultraviolet curing resin liquid at release facilitating region 37a is performed after the step (FIG. 3B) of curing the ultraviolet curing resin liquid at form stabilizing region 37c of the resin layer. As the form stabilizing region 37c that requires form precision is cured first, the resin liquid in release facilitating region 37a is supplied when form stabilizing region 37c cures and shrinks, and therefore, the form precision of form stabilizing region 37c can be improved. Further, it is desired that the outer circumference 37b of release facilitating region 37a and the form stabilizing region 37c are cured simultaneously. By simultaneous curing, the time necessary for curing can be reduced.

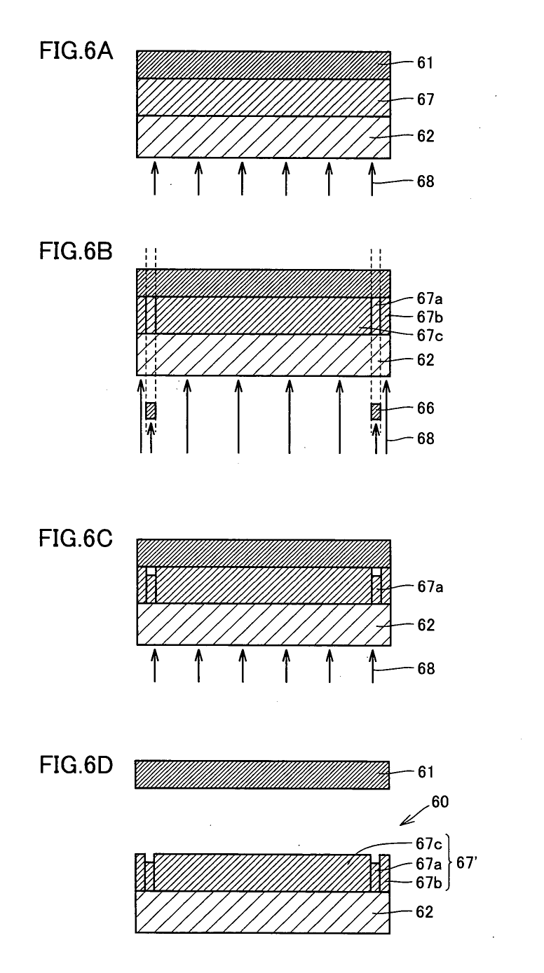

FIGS. 6A to 6D are cross sectional views showing different steps of manufacturing a compound optical element in accordance with the present invention. According to this manufacturing method, first, as shown in FIG. 6A, a liquid of ultraviolet curing resin 67 is applied to at least one of a base material 62 and a mold body 61, and arrangement of the base material and the mold body is adjusted. Then by irradiation of ultraviolet ray 68, liquid of ultraviolet curing resin 67 is cured to at most 80%. Then, as shown in FIG. 6B, by irradiation of ultraviolet ray 68 through a screen 66, the liquid of ultraviolet curing resin at outer circumference 67b of release facilitating region 67a and at form stabilizing region 67c is fully cured. Thereafter, as shown in FIG. 6C, screen 66 is removed, and again by irradiation of ultraviolet ray 68, the liquid of ultraviolet curing resin in release facilitating region 67a is cured. Finally, as shown in FIG. 6D, resin layer 67′ is released from mold body 61, whereby a compound optical element 60 having the resin layer 67′ on the surface of base material 62 is obtained.

In this manner, before fully curing the liquid of ultraviolet curing resin at outer circumference 67b of release facilitating region 67a, the liquid of ultraviolet curing resin at release facilitating region 67a is cured up to 80%, and thus, the entire time for curing can be reduced. The relation between the degree of curing (degree of polymerization) of the liquid of ultraviolet curing resin at release facilitating region 67a and the releasing property of mold body, before fully curing the liquid of ultraviolet curing resin at outer circumference 67b is shown in Table 1. As can be seen from Table 1, when the degree of curing (degree of polymerization) of the resin liquid in the release facilitating region is not higher than 80%, good releasing property is attained, and more preferable degree of curing is at most 60%. When the degree of curing of the resin liquid in release facilitating region 67a is not higher than 80%, resin can be supplied from release facilitating region 67a when the outer layer 67b is fully cured, and therefore, releasing property from the mold body can be improved.

TABLE 1

| Degree of Curing | Releasing Property |
|---|---|
| (Degree of Polymerization) (%) | (kg/12.6 mm²) |
| 0 | 0.2 |
| 20 | 0.3 |
| 40 | 0.3 |
| 60 | 0.3 |
| 80 | 1.1 |
| 100 | 1.6 |

In the step of curing the liquid of ultraviolet curing resin at the outer circumference of release facilitating region, it is preferred to intercept, attenuate or condense ultraviolet ray. By way of example, as shown in FIG. 3B, by using screen 36, release facilitating region 37a can be set at an arbitrary position. By using a filter that attenuates ultraviolet ray, when the outer circumference of release facilitating region is cured first, the release facilitating region can simultaneously be cured to some extent, and therefore, the total time of ultraviolet irradiation can be reduced and productivity can be improved. Further, use of an optical system such as a lens is preferred, as the ultraviolet ray can be condensed to the outer circumference of the release facilitating region for curing, and the time of ultraviolet irradiation can be reduced and productivity can be improved.

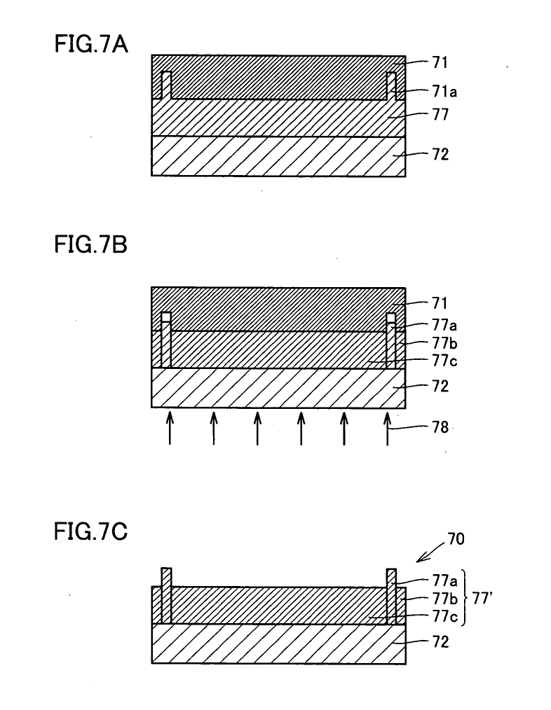

FIGS. 7A to 7C are cross sectional views showing different steps of manufacturing a compound optical element in accordance with the present invention. According to this manufacturing method, first, as shown in FIG. 7A, a liquid of ultraviolet curing resin 77 is applied to a base material 72, and arrangement of the base material and the mold body is adjusted. As shown in FIG. 7A, mold body 71 has a groove 71a at a surface to be in contact with the liquid of ultraviolet curing resin 77, and therefore, the ultraviolet curing resin is filled in groove 71a. Then, as shown in FIG. 7B, by irradiation of ultraviolet ray 78 without using any screen, the ultraviolet curing resin at release facilitating region 77a is cured to a lower degree of curing, as it is thicker than other regions. Thereafter, resin layer 77′ is released from mold body 71, whereby a compound optical element 70 having the resin layer 77′ on the surface of base material 72 such as shown in FIG. 7C is obtained.

As described above, when the liquid of ultraviolet curing resin in the release facilitating region 77a has larger thickness than the liquid of ultraviolet curing resin at the outer circumference 77b of the release facilitating region 77a, curing of release facilitating region 77a can be delayed without necessitating use of a screen, and the releasing property can be improved. The relation between the releasing property and the thickness of release facilitating region 77a when the thickness of outer circumference 77b of release facilitating region is 100 μm is shown in Table 2. As is apparent from Table 2, it is preferable that the thickness of release facilitating region 77a is made thicker by at least 20% than the thickness of outer circumference 77b to improve the releasing property, and it is more preferable when it is made thicker by at least 30%.

TABLE 2

| Thickness of Resin Layer | Releasing Property |
|---|---|
| (μm) | (kg/12.6 mm²) |
| 100 | 1.6 |
| 110 | 1.5 |
| 120 | 1.0 |
| 130 | 0.4 |
| 140 | 0.3 |

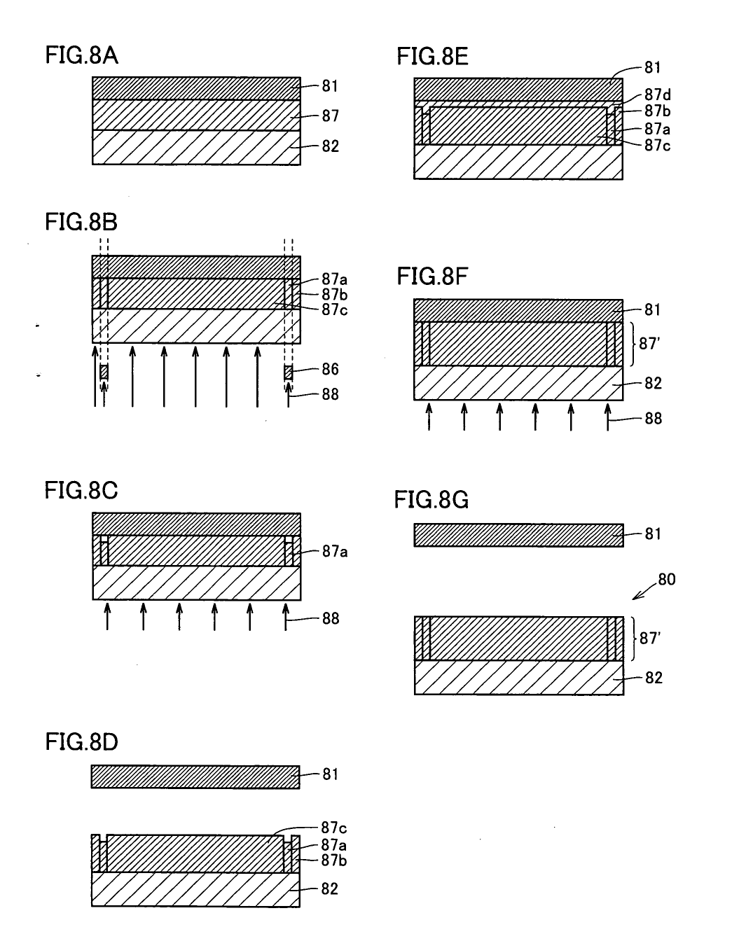

FIGS. 8A to 8G are cross sectional views showing different steps of manufacturing a compound optical element in accordance with the present invention. According to this manufacturing method, first, as shown in FIG. 8A, a liquid of ultraviolet curing resin 87 is applied to at least one of a base material 82 and a mold body 81, and arrangement of the base material and the mold body is adjusted. Then, as shown in FIG. 8B, by irradiation of ultraviolet ray 88 through a screen 86, the liquid of ultraviolet curing resin at outer circumference 87b of release facilitating region 87a and at form stabilizing region 87c is cured. Thereafter, as shown in FIG. 8C, screen 86 is removed, and again by irradiation of ultraviolet ray 88, the liquid of ultraviolet curing resin in release facilitating region 87a is cured and then released, as shown in FIG. 8D. Then, at least in the form stabilizing region, the liquid of ultraviolet curing resin is applied to at least one of the resin layer and the mold body. FIG. 8E shows an example in which liquid of ultraviolet curing resin 87d is applied to resin layers 87a, 87b and 87c. Thereafter, arrangement between the resin layer and the mold body is adjusted. Then as shown in FIG. 8F, by irradiation of ultraviolet ray 88, the ultraviolet curing resin is cured. Finally, as shown in FIG. 8G, resin layer 87′ is released from mold body 81, whereby a compound optical element 80 having the resin layer 87′ on the surface of base material 82 is obtained.

As described above, after the releasing step of separating the resin layer from mold body 81, the steps of applying liquid of ultraviolet curing resin 87d to at least one of the resin layer and the mold body at least in form stabilizing region 87c, adjusting the arrangement of resin layer and mold body, and then curing liquid of ultraviolet curing resin 87d and separating resin layer 87′ from mold body 81 are added. This approach is preferable, as the form precision of the form stabilizing region can further be improved, the mold body comes to have longer life and productivity of compound optical elements can be improved.

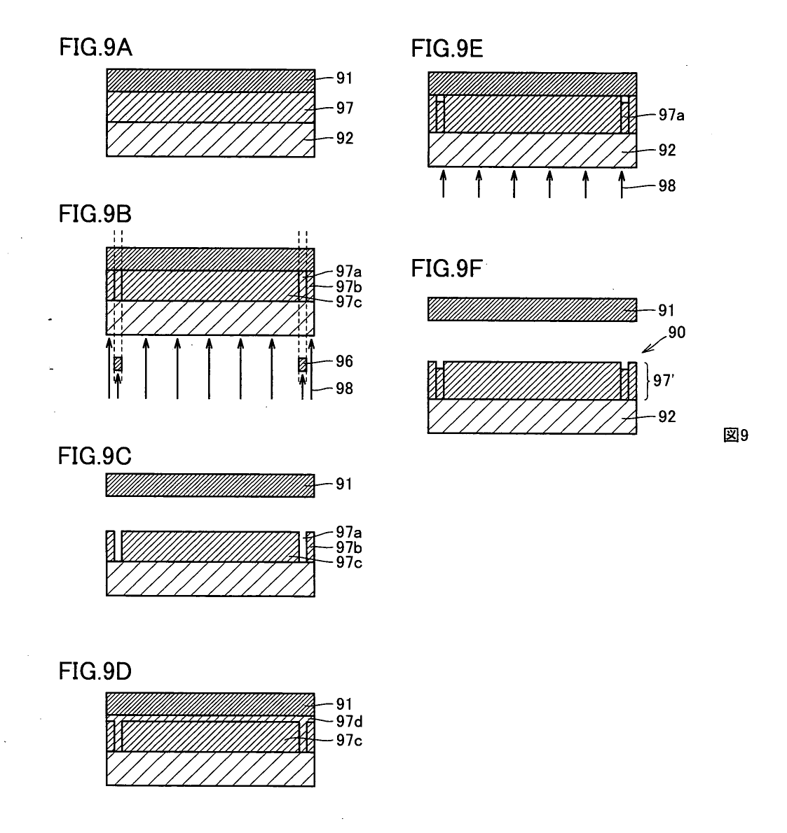

FIGS. 9A to 9F are cross sectional views showing different steps of manufacturing a compound optical element in accordance with the present invention. According to this manufacturing method, first, as shown in FIG. 9A, a liquid of ultraviolet curing resin 97 is applied to at least one of a base material 92 and a mold body 91, and arrangement of the base material and the mold body is adjusted. Then, as shown in FIG. 9B, by irradiation of ultraviolet ray 98 through a screen 96, the liquid of ultraviolet curing resin at outer circumference 97b of release facilitating region 97a and at form stabilizing region 97c is cured, and then released as shown in FIG. 9C. Then, as shown in FIG. 9D, at least in the form stabilizing region 97c, the liquid of ultraviolet curing resin 97d is applied to at least one of the resin layer and the mold body, and arrangement between the resin layer and the mold body is adjusted. Thereafter, as shown in FIG. 9E, by irradiation of ultraviolet ray 88, the ultraviolet curing resin at least at form stabilizing region 97a and release facilitating region 97c is cured. Finally, as shown in FIG. 9F, resin layer 97′ is released from mold body 91, whereby a compound optical element 90 having the resin layer 97′ on the surface of base material 92 is obtained. This manufacturing method lessens any damage to the mold body and the base material caused by tight contact between the mold body and the resin layer, and therefore, high productivity can be attained and compound optical elements having high form precision can be provided.

The compound optical element module in accordance with the present invention adopts the compound optical element manufactured through the above-described methods as a medium for condensing and/or reflecting light. Therefore, a highly precise optical element module for recording or reproducing an optical disk such as a video disk or a compact disc can be provided.

### EXAMPLE 1

In the present example, as shown in FIGS. 1A to 1D, on a commercially available glass base material 2 as a polished flat disk of 4 mm in diameter formed of BK-7, a liquid of ultraviolet curing resin 7 was applied, avoiding generation of bubbles (FIG. 1A). The liquid resin used here was prepared by mixing 5.5 mL of 3-metacryloxy propyl triethoxy silane (MPTES), 20.5 mL of ethanol, 1.65 mL of hydrochloric acid (2N) and 3.75 mL of phenyl trimethoxy silane, leaving the same at 24° C. for 72 hours, then mixing 1 mass % of 1-hydroxy cyclohexyl phenyl ketone as a photopolymerization initiator to promote ultraviolet curing property, and heating the result at 100° C. for one hour to evaporate ethanol.

Thereafter, a mold body 1 as a nickel mold subjected to aspherical machining process was placed close to base material 2 to be at a distance of 100 μm, and the arrangement of the base material and the mold body was adjusted (FIG. 1A). Then, a circular screen 6 having the diameter of 3.5 mm was arranged such that the nickel mold body 1, screen 6, and an ultraviolet lamp were aligned on one line, and from the side of glass base material 2, ultraviolet ray 8 having the central wavelength of about 365 nm and illuminance of 500 mW/cm² was emitted for 30 seconds, so that outer circumference 7b of release facilitating region 7a was cured (FIG. 1B). Thereafter, screen 6 was removed, and from the side of glass base material 2, ultraviolet ray 8 having the central wavelength of about 365 nm and illuminance of 500 mW/cm² was emitted for 30 seconds, so that release facilitating region 7a was cured (FIG. 1C). Finally, the resulting object was released from mold body 1, and thus, a compound optical element 10, 4 mm in diameter and 3.4 mm in effective diameter, having resin layer 7′ on the surface of glass base material 2 was obtained (FIG. 1D).

Referring to FIG. 1D, force exerted when the compound lens in tight contact with mold body 1 was released was measured by tensile test, and releasing property was examined. Tensile speed was set to 1 mm/sec (same in other examples). As a result, in Example 1, the force necessary for releasing was 0 kg. Then, the thickness of compound optical element 10 at release facilitating region 7a was measured, which was 100 μm, the same as the designed thickness of 100 μm. Then precision of aspherical form of the compound optical element manufactured in the present example was measured, by non-contact three-dimensional form measurement (same in other examples). As a result of measurement, it was found that form precision was 5 μm from the designed aspherical equation.

### COMPARATIVE EXAMPLE 1

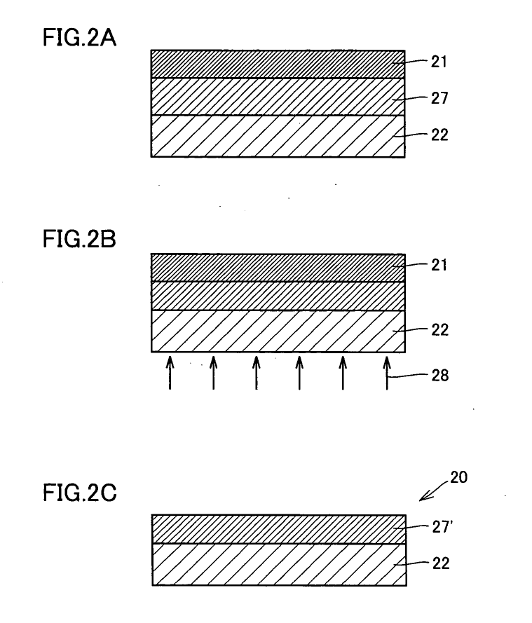

FIGS. 2A to 2C show steps of manufacturing a compound optical element in accordance with Comparative Example 1. As can be seen from FIGS. 2A to 2C, in Comparative Example 1, a compound optical element 20 was manufactured in a similar manner as Example 1, except that the ultraviolet irradiation was performed without using any screen. First, on a commercially available base material 22 as a polished flat disk of 4 mm in diameter formed of BK-7, a liquid of ultraviolet curing resin 27 was applied, and arrangement of a mold body 21 as a nickel mold subjected to aspherical machining process was adjusted, to be at a distance of 100 μm to glass base material 22 (FIG. 2A). Thereafter, from the side of base material 22, ultraviolet ray 28 having the central wavelength of about 365 nm and illuminance of 500 mW/cm² was emitted for 30 seconds, so that resin liquid 27 was cured (FIG. 2B). Finally, the resulting object was released from mold body 21, and thus, a compound optical element 20 having resin layer 27′ on the surface of glass base material 22 was obtained (FIG. 2C).

As in Example 1, the force at the time of releasing was measured, and it was 1.6 kg. Consequently, it was found that by providing a release facilitating region, curing the outer portion thereof first, and curing the release facilitating region thereafter, the releasing property can be improved. Further, the measured film thickness was 100 μm in Example 1 and 94 μm in Comparative Example 1, as compared with the designed thickness of 100 μm. It may be the case that in Example 1, change in film thickness as the resin layer shrunk was supported by the outer circumferential region of the release facilitating layer, and hence, the resin layer could be formed as designed, and film thickness accuracy could be improved. Then, form precision was measured, and it was 5 μm in Example 1 and 2 μm in Comparative Example 1, as regards the designed aspherical equation. The reason for this is that in Example 1, the resin liquid was not supplied when the resin in the release facilitating region shrunk, and therefore, the resin shrunk more than in Comparative Example 1 in which resin was supplied, resulting in lower form precision.

### EXAMPLE 2

In the present example, as shown in FIGS. 3A to 3D, on a commercially available base material 32 as a polished flat disk of 4 mm in diameter formed of BK-7, a liquid of ultraviolet curing resin 37 was applied, avoiding generation of bubbles. Thereafter, a mold body 31 as a nickel mold subjected to aspherical machining process was placed close to glass base material 32 to be at a distance of 100 μm (FIG. 3A). Then, on the side of base material 32, a circular screen 36 having an outer diameter of 3.8 mm and inner diameter of 3.4 mm was arranged, and from the side of glass base material 32, ultraviolet ray 38 having the central wavelength of about 365 nm and illuminance of 500 mW/cm² was emitted for 30 seconds, so that portions other than the release facilitating region 37a were cured (FIG. 3B). Thereafter, screen 36 was removed, and from the side of glass base material 32, ultraviolet ray 38 having the central wavelength of about 365 nm and illuminance of 500 mW/cm² was emitted for 30 seconds, so that release facilitating region 37a was cured (FIG. 3C). Finally, the resulting object was released from mold body 31, and thus, a compound optical element 30, 4 mm in diameter and 3.4 mm in effective diameter, having resin layer 37′ on the surface of base material 32 was obtained (FIG. 3D). In the compound optical element 30, release facilitating region 37a was provided on the outer circumference of form stabilizing region 37c.

Releasing property of the obtained compound optical element 30 was studied in the similar manner. The force at the time of releasing was 0.2 kg, and as compared with 1.6 kg of Comparative Example 1, the releasing property could be improved even when the release facilitating region 37a was cured last. Further, the film thickness of form stabilizing region 37c was measured in the similar manner, which was 100 μm and the same as the designed thickness of 100 μm. Therefore, film thickness control was possible even when release facilitating region 37a was cured last. Then, form precision of form stabilizing region 37c was measured, which was 0.5 μm. It was found that when release facilitating region 37a was cured last, form precision could further be improved.

### EXAMPLE 3

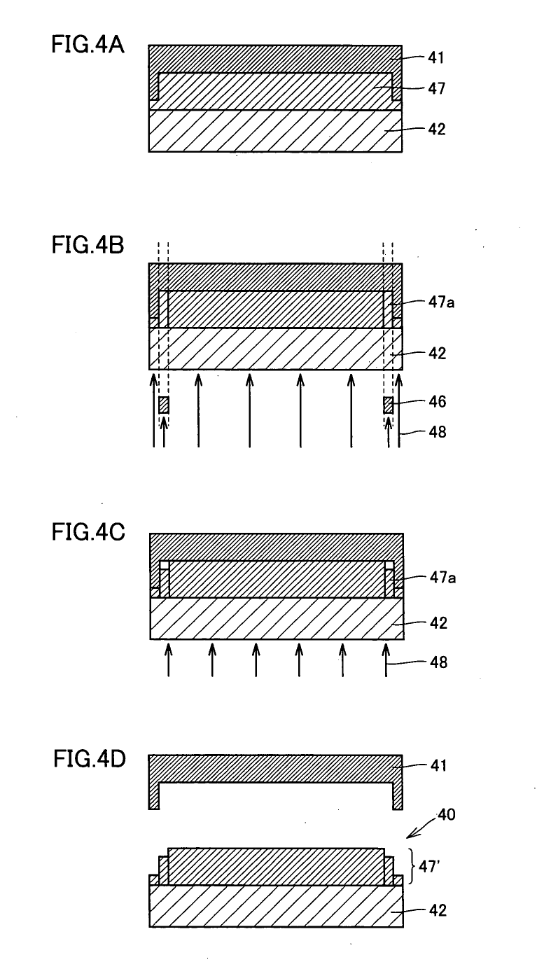

FIGS. 4A to 4D are cross sectional views showing another method of manufacturing a compound optical element in accordance with the present example. As shown in FIGS. 4A to 4D, on a commercially available base material 42 as a polished flat disk of 4 mm in diameter formed of BK-7, a liquid of ultraviolet curing resin 47 was applied, avoiding generation of bubbles, and thereafter, arrangement of a mold body 41 was adjusted, to be at a distance of 100 μm to base material 42 (FIG. 4A). As shown in FIG. 4A, mold body 41 was a nickel metal mold subjected to aspherical machining process, having a glass lens support on an outer circumference. Then, on the side of base material 42, a circular screen 46 having an outer diameter of 3.8 mm and inner diameter of 3.4 mm was arranged, and from the side of base material 42, ultraviolet ray 48 having the central wavelength of about 365 nm and illuminance of 500 mW/cm² was emitted for 30 seconds, so that portions other than the release facilitating region 47a were cured (FIG. 4B). Thereafter, screen 46 was removed, and from the side of glass base material 42, ultraviolet ray 48 having the central wavelength of about 365 nm and illuminance of 500 mW/cm² was emitted for 30 seconds, so that release facilitating region 47a was cured (FIG. 4C). Finally, the resulting object was released from mold body 41, and thus, a compound optical element 40, 4 mm in diameter and 3.4 mm in effective diameter, having resin layer 47′ on the surface of base material 42 was obtained (FIG. 4D).

Releasing property of the obtained compound optical element 40 was studied, and the force exerted at the time of releasing was 0.2 kg. The thickness of form stabilizing region was 100 μm, that is, the same as the designed thickness of 100 μm. Aspherical form precision was 0.5 μm.

### COMPARATIVE EXAMPLE 2

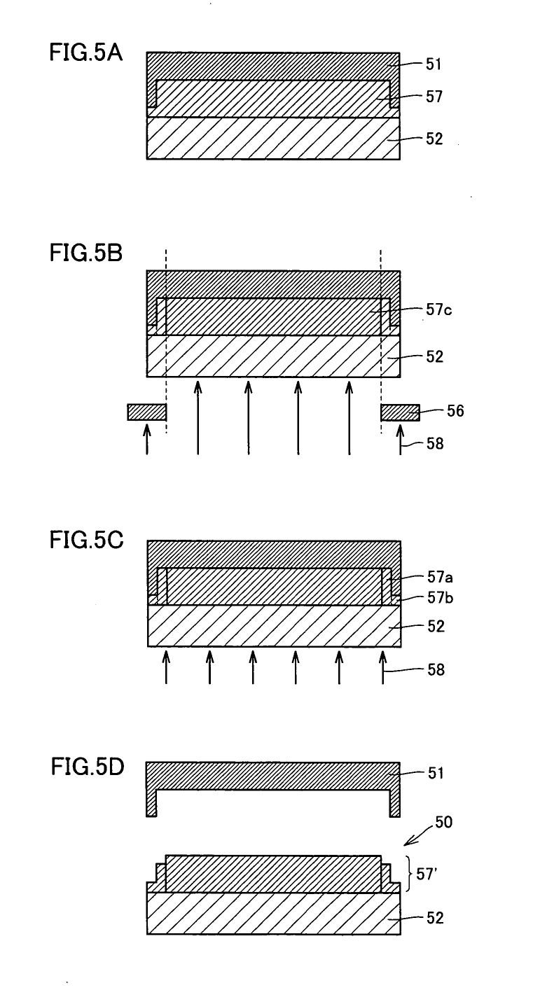

FIGS. 5A to 5D show steps of manufacturing a compound optical element in accordance with Comparative Example 2. As shown in FIGS. 5A to 5D, in Comparative Example 2, on a commercially available base material 52 as a polished flat disk of 4 mm in diameter formed of BK-7, a liquid of ultraviolet curing resin 57 was applied, avoiding generation of bubbles (FIG. 5A). Thereafter, arrangement of base material 52 and mold body 51 was adjusted in the similar manner as in Example 3 (FIG. 5A). Then, on the side of glass base material 52, a circular screen 56 having an outer diameter of 4.5 mm and inner diameter of 3.4 mm was arranged, and from the side of glass base material 52, ultraviolet ray 58 having the central wavelength of about 365 nm and illuminance of 500 mW/cm² was emitted for 30 seconds, so that form stabilizing region 57c was cured (FIG. 5B). Thereafter, screen 56 was removed, and from the side of glass base material 52, ultraviolet ray 58 having the central wavelength of about 365 nm and illuminance of 500 mW/cm² was emitted for 30 seconds, so that release facilitating region 57a and its outer circumference 57b were cured (FIG. 5C). Finally, the resulting object was released from mold body 51, and thus, a compound optical element 50, 4 mm in diameter and 3.4 mm in effective diameter, having resin layer 57′ on the surface of base material 52 was obtained (FIG. 5D).

Releasing property of the obtained compound optical element 50 was studied, and the force exerted at the time of releasing was 1.6 kg in Comparative Example 2, while it was 0.2 kg in Example 3. From this result, it was understood that even when a glass support was provided on the outer circumference of the mold body, releasing property could be improved by curing the release facilitating region 57a later than the outer circumference 57b. The thickness of form stabilizing region was measured, and the thickness was 100 μm both in Example 3 and Comparative Example 2, while the designed thickness was 100 μm. From this result, it was understood that the film thickness could be controlled even when a metal mold having a support of the glass base material on the outer circumference was used. Further, aspherical form precision of the compound optical element in the form stabilizing region was measured, and form precision was 0.5 μm in Example 3 and Comparative Example 2. From this result, it was understood that the form precision could be improved even when a metal mold having a support of the glass base material on the outer circumference was used.

### EXAMPLE 4

As shown in FIGS. 6A to 6D, on a commercially available base material 62 as a polished flat disk of 4 mm in diameter formed of BK-7, a liquid of ultraviolet curing resin 67 was applied, avoiding generation of bubbles and thereafter, arrangement of a mold body 61 as a nickel mold subjected to aspherical machining process was adjusted to be at a distance of 100 μm from the glass base material 62 (FIG. 6A). Then, without using any screen, from the side of glass base material 62, ultraviolet ray 68 having the central wavelength of about 365 nm and illuminance of 500 mW/cm² was emitted for 18 seconds, so that the liquid resin as a whole was cured approximately to 60% in degree of polymerization (FIG. 6A). Then, on the side of glass base material 62, a screen 66 having an outer diameter of 3.8 mm and inner diameter of 3.4 mm was arranged, and from the side of glass base material 62, ultraviolet ray 68 having the central wavelength of about 365 nm and illuminance of 500 mW/cm² was emitted for 12 seconds, so that portions other than the release facilitating region 67a were cured (FIG. 6B). Thereafter, screen 66 was removed, and from the side of glass base material 62, ultraviolet ray 68 having the central wavelength of about 365 nm and illuminance of 500 mW/cm² was emitted for 12 seconds, so that release facilitating region 67a was cured (FIG. 6C). Finally, the resulting object was released from mold body 61, and thus, a compound optical element 60, 4 mm in diameter and 3.4 mm in effective diameter, having resin layer 67′ on the surface of base material 62 was obtained (FIG. 6D).

Releasing property of the obtained compound optical element 60 was studied, and the force was 0.3 kg. It was found that high releasing property could be attained even when the release facilitating region 67a was cured to about 60%, then the outer circumference 67b of release facilitating region 67a was cured and finally the release facilitating region 67a was cured. Further, the thickness of form stabilizing region was measured, and it was 100 μm, that is, the same as the designed thickness of 100 μm. It was found that film thickness control was possible even when the release facilitating region 67a was cured to about 60%, then the outer circumference 67b of release facilitating region 67a was cured and finally the release facilitating region 67a was cured. Then, aspherical form precision of form stabilizing region of the compound optical element was measured, which was 0.5 μm. It was found that form precision could be improved even when the release facilitating region 67a was cured to about 60%, then the outer circumference 67b of release facilitating region 67a was cured and finally the release facilitating region 67a was cured. Further, the total time of ultraviolet irradiation in the present example could be made shorter to 42 seconds, from the total time of ultraviolet irradiation of 60 seconds in Example 2.

### EXAMPLE 5

In the present example, as shown in FIGS. 3A to 3D, on a commercially available base material 32 as a polished flat disk of 4 mm in diameter formed of BK-7, a liquid of ultraviolet curing resin 37 was applied, avoiding generation of bubbles, and thereafter, arrangement of a mold body 31 as a nickel mold subjected to aspherical machining process was adjusted to be at a distance of 100 μm from the glass base material 32 (FIG. 3A). Then, on the side of base material 32, an ultraviolet ray attenuating plate 36, which was formed of glass and had an outer diameter of 3.8 mm and inner diameter of 3.4 mm and transmittance of light having the wavelength of 365 nm of 20%, was arranged, and from the side of glass base material 32, ultraviolet ray 38 having the central wavelength of about 365 nm and illuminance of 500 mW/cm² was emitted for 30 seconds, so that portions other than the release facilitating region 37a were cured (FIG. 3B). Thereafter, ultraviolet ray attenuating plate 36 of glass was removed, and from the side of base material 32, ultraviolet ray having the central wavelength of about 365 nm and illuminance of 500 mW/cm² was emitted for 24 seconds, so that release facilitating region 37a was cured (FIG. 3C). Finally, the resulting object was released from mold body 31, and thus, a compound optical element 30, 4 mm in diameter and 3.4 mm in effective diameter, having resin layer 37′ on the surface of base material 32 was obtained (FIG. 3D).

Releasing property of the obtained compound optical element was studied, and the force exerted at the time of releasing was 0.3 kg. Considering that the tensile force of 0.2 kg was necessary in Example 2 using a screen, it was understood that releasing property could be improved even when an ultraviolet ray attenuating plate of glass was used in place of the screen. Next, the thickness of form stabilizing region was measured, and the thickness was 100 μm both in Example 2 and in the present example, while the designed thickness was 100 μm. From this result, it was understood that the film thickness could be controlled even when an ultraviolet ray attenuating plate of glass was used in place of the screen of Example 2. Further, aspherical form precision of form stabilizing region was measured, which was 0.5 μm in Example 2 and 0.5 μm in the present example. It was found that form precision could be improved even when an ultraviolet ray attenuating plate of glass was used in place of the screen of Example 2. In Example 2, the total time of ultraviolet irradiation was 60 seconds, while it could be reduced to 54 seconds in the present example.

### EXAMPLE 6

As shown in FIGS. 7A to 7C, on a commercially available base material 72 as a polished flat disk of 4 mm in diameter formed of BK-7, a liquid of ultraviolet curing resin 77 was applied, avoiding generation of bubbles. Thereafter, at an outer circumference 77a of form stabilizing region 77c, a nickel 1 mold body 71 subjected to aspherical machining process and having an annular groove of 30 μm in depth and 200 μm in width was arranged to be at a distance of 100 μm from the glass base material 72. Then, the liquid resin was filled in the groove of mold body 71, and the thickness of liquid resin in release facilitating region 77a attained to 130 μm. The thickness of liquid resin at other regions was 100 μm, and hence, the thickness of release facilitating region 77a was increased by 30% (FIG. 7A). Then, from the side of glass base material 72, ultraviolet ray 78 having the central wavelength of about 365 nm and illuminance of 500 mW/cm² was emitted for 30 seconds, without using any screen or the like (FIG. 7B). Release facilitating region 77a was not fully cured as it was thick, while other regions were fully cured. Finally, the resulting object was released from mold body 71, and thus, a compound optical element 70, 4 mm in diameter and 3.4 mm in effective diameter, having resin layer 77′ on the surface of base material 72 was obtained (FIG. 7C).

Releasing property of the obtained compound optical element was studied, and the force exerted at the time of releasing was 0.4 kg. Thus, it was understood that releasing property could be improved even when the thickness of release facilitating region 77a was increased. Further, the thickness of the compound optical element was measured, and the actual thickness of form stabilizing region 77c was 100 μm, that is, the same as the designed thickness of 100 μm. It was found that film thickness control in form stabilizing region 77c was possible even when the thickness of release facilitating region 77a was increased. Further, aspherical form precision of form stabilizing region was measured, which was 0.6 μm, and it was found that form precision could be improved even when the thickness of release facilitating region 77a was increased.

### EXAMPLE 7

As shown in FIGS. 8A to 8G, on a commercially available base material 82 as a polished flat disk of 4 mm in diameter formed of BK-7, a liquid of ultraviolet curing resin 87 was applied, avoiding generation of bubbles. Thereafter, arrangement of a mold body 81 as a nickel mold subjected to aspherical machining process was adjusted to be at a distance of 100 μm from the glass base material 82 (FIG. 8A). Then, on the side of glass base material 82, a screen 86 having an outer diameter of 3.8 mm and inner diameter of 3.4 mm was arranged, and from the side of base material 82, ultraviolet ray 88 having the central wavelength of about 365 nm and illuminance of 500 mW/cm² was emitted for 30 seconds, so that portions other than the release facilitating region 87a were cured (FIG. 8B). Thereafter, screen 86 was removed, and from the side of glass base material 82, ultraviolet ray 88 having the central wavelength of about 365 nm and illuminance of 500 mW/cm² was emitted for 30 seconds, so that release facilitating region 87a was cured (FIG. 8C). Thereafter, the resulting object was released from mold body (FIG. 8D), and on the resin layer including form stabilizing region 87c, a liquid resin 87d was applied, and the arrangement of mold body 81 subjected to aspherical machining process and the resin layer was adjusted (FIG. 8E). Thereafter, from the side of glass base material 82, ultraviolet ray 88 having the central wavelength of about 365 nm and illuminance of 500 mW/cm² was emitted for 30 seconds for curing (FIG. 8F). Finally, the resulting object was released from mold body 81, and thus, a compound optical element 80, 4 mm in diameter and 3.4 mm in effective diameter, having resin layer 87′ on the surface of base material 82 was obtained (FIG. 8G).

Releasing property of the obtained compound optical element was studied, and the force exerted at the time of first releasing was 0.2 kg, and at the time of second releasing, it was 1.6 kg. Therefore, it was found that when molding was done twice, releasing property at the first releasing could be improved. Next, the thickness of form stabilizing region was measured, and the thickness was 101 μm, while the designed thickness was 100 μm. It was found that film thickness could be controlled even when the outer circumference 87b of release facilitating region 87a was cured at the first time and portions including the release facilitating region were cured at the second time. Then, form precision of form stabilizing region was measured, which was 0.3 μm. Thus, it was found that the form precision could further be improved when the outer circumference 87b of release facilitating region was cured at the first time and portions including the release facilitating region 87a were cured at the second time.

### EXAMPLE 8

As shown in FIGS. 9A to 9F, on a commercially available base material 92 as a polished flat disk of 4 mm in diameter formed of BK-7, a liquid of ultraviolet curing resin 97 was applied, avoiding generation of bubbles, and thereafter, arrangement of a mold body 91 as a nickel mold subjected to aspherical machining process was adjusted to be at a distance of 100 μm from the glass base material 92 (FIG. 9A). Then, on the side of glass base material 92, a screen 96 having an outer diameter of 3.8 mm and inner diameter of 3.4 mm was arranged, and from the side of glass base material 92, ultraviolet ray 98 having the central wavelength of about 365 nm and illuminance of 500 mW/cm² was emitted for 30 seconds, so that portions other than the release facilitating region 97a were cured (FIG. 9B). Thereafter, the resulting object was released from mold body 91, the resin liquid was washed (FIG. 9C), a liquid of ultraviolet curing resin 97d was applied to the resin layer including form stabilizing region 97c, and then the arrangement of mold body 91 subjected to aspherical machining process and the resin layer was adjusted (FIG. 9D). Thereafter, from the side of glass base material 92, ultraviolet ray 98 having the central wavelength of about 365 nm and illuminance of 500 mW/cm² was emitted for 30 seconds without using the screen, for curing (FIG. 9E). Finally, the resulting object was released from mold body 91, and thus, a compound optical element 90, 4 mm in diameter and 3.4 mm in effective diameter, having resin layer 97′ on the surface of base material 92 was obtained (FIG. 9F).

Releasing property of the obtained compound optical element was studied, and the force exerted at the time of releasing was 0.2 kg. From this result, it was found that releasing property could be improved even when the outer circumference 97b of release facilitating region 97a was cured at the first time and the portions including release facilitating region 97a were cured at the second time. Next, the thickness of form stabilizing region was measured, and the thickness was 101 μm, while the designed thickness was 100 μm. It was found that film thickness could be controlled even when the outer circumference 97b of release facilitating region 97a was cured at the first time and the portions including release facilitating region 97a were cured at the second time. Further, aspherical form precision of form stabilizing region was measured, which was 0.3 μm, and it was found that form precision could further be improved when the outer circumference 97b of release facilitating region 97a was cured at the first time and the portions including release facilitating region 97a were cured at the second time.

In the examples above, ultraviolet ray was directed from the side of glass base material, and the ultraviolet curing resin was cured by the ultraviolet ray that has passed through the glass base material. When a mold body formed of a material that passes the ultraviolet ray, such as quarts, is used, it is possible to direct ultraviolet ray from the side of the transparent mold and to cure the resin by the ultraviolet ray that has passed through the mold body. In the examples, the liquid of ultraviolet curing resin was applied to the base material and then the mold was placed on the base material. Another approach in which the liquid of ultraviolet curing resin is applied to the mold body and thereafter the mold body is placed on the base material, is also effective. Further, an approach in which the liquid of ultraviolet curing resin is applied both to the base material and the mold body and then the base material and the mold body are arranged, is similarly effective.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A method of manufacturing a compound optical element having a resin layer on a surface of a base material, comprising the steps of:
applying a liquid of ultraviolet curing resin to at least one of the base material and a mold body;
adjusting arrangement of the base material and the mold body;
curing the liquid of ultraviolet curing resin at an outer circumference of a release facilitating region provided to ease releasing from the mold body;
curing the liquid of ultraviolet curing resin at the release facilitating region; and
releasing step of separating a resin layer formed by curing from the mold body.

2. The method of manufacturing a compound optical element according to claim 1, wherein
said release facilitating region is provided at least on a portion of a region outer than a form stabilizing region for stabilizing the form of the resin layer.

3. The method of manufacturing a compound optical element according to claim 1, wherein
said step of curing the liquid of ultraviolet curing resin at the release facilitating region is performed after a step of curing the liquid of ultraviolet curing resin at a form stabilizing region of the resin layer.

4. The method of manufacturing a compound optical element according to claim 1, wherein
before fully curing the liquid of ultraviolet curing resin at an outer circumference of the release facilitating region, the liquid of ultraviolet curing resin at the release facilitating region is cured to at most 80%.

5. The method of manufacturing a compound optical element according to claim 1, wherein
in the step of curing the liquid of ultraviolet curing resin at an outer circumference of the release facilitating region, the ultraviolet ray is intercepted, attenuated or condensed.

6. The method of manufacturing a compound optical element according to claim 1, wherein
the liquid of ultraviolet curing resin in the release facilitating region is larger in thickness by at least 20% than the liquid of ultraviolet curing resin at the outer circumference of the release facilitating region.

7. The method of manufacturing a compound optical element according to claim 1, further comprising, after the releasing step of separating the resin layer from the mold body, the following steps of
at least in the form stabilizing region, applying a liquid of ultraviolet curing resin to at least one of the resin layer and the mold body;
adjusting arrangement of the resin layer and the mold body;
curing said liquid of ultraviolet curing resin; and
releasing step of separating a resin layer formed by curing from the mold body.

8. A method of manufacturing a compound optical element having a resin layer on a surface of a base material, comprising the steps of:
applying a liquid of ultraviolet curing resin to at least one of the base material and a mold body;
adjusting arrangement of the base material and the mold body;
curing the liquid of ultraviolet curing resin at an outer circumference of a release facilitating region and at a form stabilizing region;
releasing step of separating a resin layer formed by curing from the mold body;
at least in the form stabilizing region, applying a liquid of ultraviolet curing resin to at least one of the resin layer and the mold body;
adjusting arrangement of the resin layer and the mold body;
curing the liquid of ultraviolet curing resin at least in the form stabilizing region and in the release facilitating region; and
releasing step of separating a resin layer formed by curing from the mold body.

9. A compound optical element module using the compound optical element manufactured by the method according to claim 1, as a medium for condensing and/or reflecting light.
